(19) United States
(12) Patent Application Publication
(10) Pub. No.: US 2015/0151764 A1
(43) Pub. Date: Jun. 4, 2015

(54) VEHICLE BODY VIBRATION CONTROL DEVICE FOR VEHICLE

(71) Applicant: TOYOTA JIDOSHA KABUSHIKI KAISHA, Toyota-shi (JP)

(72) Inventors: Mitsuhiko MORITA, Sunto-gun (JP); Hirofumi MOMOSE, Numazu-shi (JP); Takashi SAITO, Fuji-shi (JP); Shotaro SASAKI, Susono-shi (JP)

(73) Assignee: TOYOTA JIDOSHA KABUSHIKI KAISHA, Toyota-shi (JP)

(21) Appl. No.: 14/555,069

(22) Filed: Nov. 26, 2014

(30) Foreign Application Priority Data
Nov. 29, 2013 (JP) 2013-248601

(51) Int. Cl. B60W 30/20; B60W 10/10; B60W 10/04

(52) U.S. Cl. CPC B60W 30/20; B60W 10/04; B60W 10/10

(57) ABSTRACT

A vehicle body vibration control device (10) for a vehicle, including a request driving force calculation unit (20) calculating a driver's request driving force, a driving unit (16) applying a driving force to a vehicle (12), a driving force control unit (22) controlling the driving unit based on a command driving force, a notch filter (24) configured to receive a signal indicating the request driving force, process the signal so as to reduce a frequency component of vibration of a vehicle body, and output the processed signal to the driving force control unit as a signal indicating the command driving force, and a notch filter control unit (26) configured to variably set the notch degree of the notch filter on the basis of whether or not the driver's request driving force increases.

### BACKGROUND OF THE INVENTION

1. Field of the Invention

The present invention relates to a vehicle body vibration control device for a vehicle such as an automobile, and more particularly, to a vehicle body vibration control device configured to suppress vibration of a vehicle body, which is caused by fluctuation in driving force of the vehicle.

2. Description of the Related Art

Vehicles such as automobiles travel by a driving force generated by a driving unit such as an engine. Fluctuation in driving force generated from the driving unit causes loads to be applied on the vehicle body in a fore-and-aft direction and a vertical direction of the vehicle relative to wheels. Thus, pitching vibration occurs in the vehicle body. Therefore, it has been suggested that the pitching vibration of the vehicle body be reduced through appropriate control of a command driving force to the driving unit.

For example, Japanese Patent Application Laid-open No. 2007-237879 filed by the applicant of this application describes a vehicle body vibration control device configured based on the above-mentioned concept. This vehicle body vibration control device includes a request driving force calculation unit configured to calculate a driver's request driving force, a driving unit configured to apply a driving force to a vehicle, a driving force control unit configured to control the driving unit based on a command driving force, and a notch filter configured to receive a signal indicating the notch filter has a notch frequency set to a value for reducing a frequency component of vibration of a vehicle body. The notch filter subjects the signal to filter processing, and outputs the processed signal to the driving force control unit as a signal indicating the command driving force.

According to the vehicle body vibration control device of this type, the signal indicating the driver's request driving force is processed by the notch filter, and the driving unit is controlled based on the command driving force reduced in frequency component of the vibration of the vehicle body. As a result, the pitching vibration of the vehicle body can be reduced.

The effect of a notch filter restraining the vibration of the vehicle body varies in accordance with the notch degree of the filter, i.e., the degree reducing a notch frequency component. When the notch degree is set to a high value, the effect of suppressing the vibration of the vehicle body increases. However, the change in the command driving force output to the driving unit is reduced and the delay of the command driving force with respect to the request driving force becomes large. For that reason, the notch degree of the notch filter is preset to a constant value so that the time delay of the command driving force relative to the request driving force does not become excessive while making the effect of a notch filter suppressing the vibration of the vehicle body as high as possible.

However, even the driver's request driving force is the same, the optimum value for the notch degree of the notch filter varies in accordance with whether the request driving force increases or decreases, i.e., whether the driver's request is acceleration or deceleration.

That is, as the driving unit has a delay in response, when the driver's request is acceleration, the increase change in the actual driving force delays from the driver's operation for increasing the driving force and the delay time increases as the change rate of the request driving force increases. On the contrary, as engine brake and travelling drag of the vehicle act substantially at the same time as the driver's operation for decreasing the driving force is conducted, when the driver's request is deceleration, the delay time is short in which the decrease change in the actual driving force delays from the driver's operation for decreasing the driving force. In consequence, the notch degree of the notch filter is preferably set to a value that varies in accordance with whether or not the driver's request driving force increases. In general, in a higher vehicle speed range, the notch degree to be set when the request driving force increases is preferably smaller than that to be set when the request driving force decreases. On the contrary, in a lower vehicle speed range, the notch degree to be set when the request driving force increases is preferably larger than that to be set when the request driving force decreases.

It is to be noted that the vehicle body vibration control device described in the above-mentioned Laid-open publication, the notch frequency is variably set in accordance with vehicle speed, engine speed, deceleration ratio and the like so that the vibration of the vehicle body is reduced as well as possible while satisfying the driver's driving request as much as possible. However, the notch degree cannot be optimized by means of variably setting the notch frequency in accordance with vehicle speed and the like.

### SUMMARY OF THE INVENTION

It is a main object of the present invention to variably set the notch degree to a value that varies in accordance with whether or not the driver's request driving force increases so that the vibration of the vehicle body is reduced as well as possible while satisfying the driver's driving request as much as possible.

The present invention provides a vehicle body vibration control device for a vehicle, comprising: a request driving force calculation unit configured to calculate a request driving force, which is requested by a driver; a driving unit configured to apply a driving force to the vehicle; a driving force control unit configured to control the driving unit based on a command driving force; and a notch filter configured to receive a signal indicating the request driving force from the request driving force calculation unit, subject the signal to filter processing, and output the signal subjected to the filter processing to the driving force control unit as a signal indicating the command driving force, the notch filter having a notch frequency set to a value for reducing a frequency component of vibration of a vehicle body. The vehicle body vibration control device comprises a notch filter control unit configured to determine as to whether or not the driver's request driving force increases and variably set the notch degree of the notch filter on the basis of the result of the determination.

According to the above-mentioned configuration, the signal indicating the request driving force is processed by the notch filter having the notch frequency set to the value for reducing the frequency component of the vibration of the vehicle body, and the processed signal is output to the driving force control unit as the signal indicating the command driving force. Then, determination is made by the notch filter control unit whether or not the driver's request driving force increases and the notch degree of the notch filter is variably set on the basis of the result of the determination.

Accordingly, the notch degree of the notch filter can be set to an optimum value in accordance with whether or not the driver's request driving force increases. In consequence, in comparison with a conventional vehicle body vibration control device in which the notch degree of the notch filter is constant, in both cases where the driver's request is acceleration and deceleration, the signal indicative of the driver's request driving force can more favorably be processed by the notch filter avoiding excess or deficiency in the notch degree. In other words, a risk can be reduced that the effect for restraining vehicle vibration is insufficient due to deficiency in the notch degree, or, conversely, the effect for restraining vehicle vibration is excessive causing excessive delay of the actual driving force relative to the request driving force.

According to one embodiment of the present invention, in the above-mentioned configuration, the notch filter control unit, when it determined that the request driving force does not increase or decrease, may set the notch degree of the notch filter to a value that is equal to one of the notch degree set when it is determined that the request driving force increases or the notch degree set when it is determined that the request driving force decreases.

In general, as the driving force of a vehicle does not substantially change when the driver's request driving force does not increase or decrease, the vehicle body is not vibrated by the variation in the driving force of the vehicle and, accordingly, the signal indicating the request driving force needs not to be processed by the notch filter. In consequence, when the driver's request driving force does not increase or decrease, the notch degree of the notch filter may be an arbitrary value. Therefore, when it was determined that the driver's request driving force does not increase or decrease, the notch degree may be either of an appropriate value set when the request driving force increases or an appropriate value set when the request driving force decreases.

According to the above-mentioned configuration, when it was determined that the request driving force does not increase or decrease, the notch degree of the notch filter is set to a value that is equal to one of the notch degree set when it was determined that the request driving force increases or the notch degree set when it was determined that the request driving force decreases. Therefore, as compared to the case where the notch degree is set to a value that is different from the appropriate notch degree set when the request driving force increases or decreases, the control of the notch degree can be made simpler.

### BRIEF DESCRIPTION OF THE DRAWINGS

FIG. 1 is a block diagram illustrating a vehicle body vibration control device for a vehicle according to an embodiment of the present invention, which is applied to a rear-wheel-drive vehicle including an engine and a transmission in combination as a driving unit.

FIG. 2 is a flowchart showing a routine for controlling a notch degree which is achieved by a notch filter control block in an electronic control unit.

FIG. 3 is a graph showing an example of frequency characteristics of the notch filter, in other words, a relationship between a frequency and a gain.

FIG. 4 is a map for calculating a driver's request driving force based on a vehicle speed and an accelerator opening.

### DETAILED DESCRIPTION OF THE PREFERRED EMBODIMENTS

Now, exemplary embodiments of the present invention are described in detail referring to the accompanying drawings.

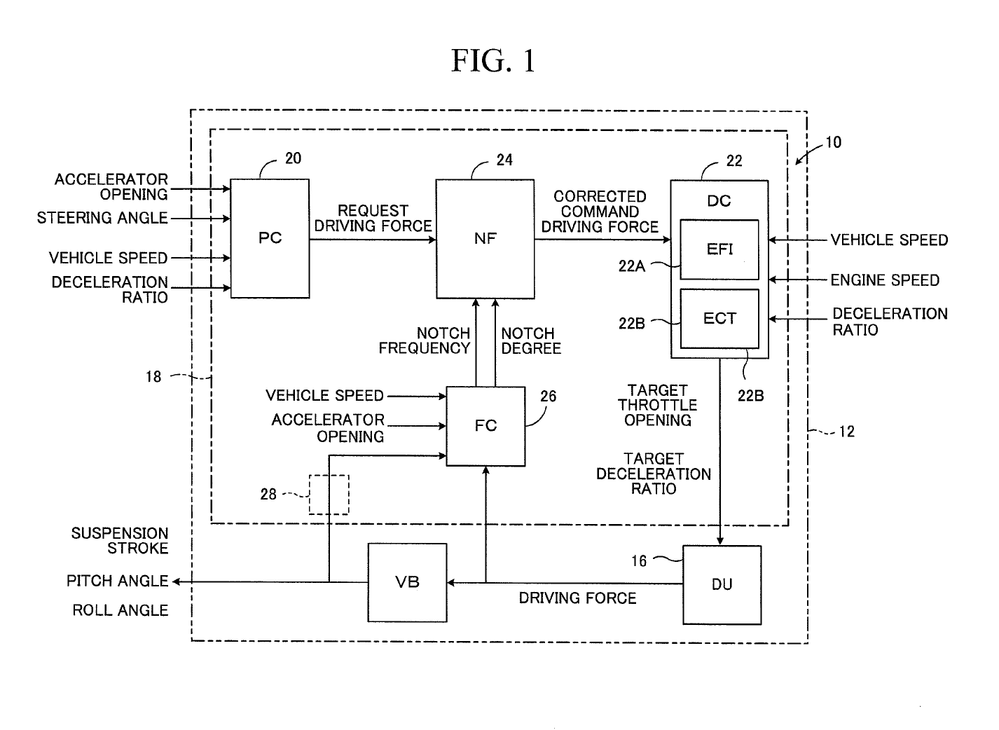

FIG. 1 is a block diagram illustrating a vehicle body vibration control device 10 for a vehicle according to an embodiment of the present invention. In FIG. 1, the vehicle body vibration control device 10 is mounted on a vehicle 12, and includes a vehicle body (VB) 14, a driving unit (DU) 16 configured to apply a driving force to the vehicle 12 by applying driving toque to drive wheels, and an electronic control unit (ECU) 18 configured to control the driving unit 16. In the illustrated embodiment, the driving unit 16 includes an engine and a transmission (gear type automatic transmission, continuously variable transmission, or dual clutch transmission) in combination. However, the driving unit 16 may be another driving unit such as a hybrid system or an electric motor. The electronic control unit 18 may be an arbitrary electronic control unit having a calculation function and a storage function, for example, as in the case of a microcomputer.

The electronic control unit 18 includes a request driving force calculation block (PC) 20 configured to calculate a driver's request driving force, and a driving force control block (DC) 22 configured to output a signal for controlling a driving force to the driving unit 16. Signals indicating an accelerator opening and a steering angle, which correspond to a driver's steering operation amount, and signals indicating a vehicle speed and a deceleration ratio of the transmission, which correspond to parameters indicating a driving state of the vehicle, are input to the request driving force calculation block 20. The request driving force calculation block 20 calculates a driver's request driving force based on the accelerator opening, the steering angle, the vehicle speed, and the deceleration ratio, or another arbitrary driving force calculation input parameter in addition to those parameters.

A signal indicating the driver's request driving force is input to a notch filter (NF) 24. The notch filter 24 suppresses or blocks transmission of a notch frequency component among frequency components included in the signal indicating the request driving force to reduce the notch frequency component. In this case, the notch frequency is basically set to a resonance frequency of the vehicle body. The signal indicating the request driving force (command driving force) corrected through processing of the notch filter 24 is input to the driving force control block 22.

The driving force control block 22 includes an electronic fuel injection (EFI) system control unit 22A and an electronic control transmission (ECT) control unit 22B. The driving force control block 22 determines a target throttle opening and a target deceleration ratio based on the parameters of the command driving force, the vehicle speed, an engine speed, and a deceleration ratio, and the driving force control block 22 outputs signals indicating those target throttle opening and target deceleration ratio to the driving unit 16.

The engine is controlled based on the target throttle opening, and the transmission is controlled based on the target deceleration ratio. Accordingly, the driving unit 16 applies a driving force corresponding to the command driving force to the vehicle 12 including the vehicle body 14. When the driving force is applied to the vehicle 12 and fluctuates, the vehicle body 14 of the vehicle vibrates. In particular, vibration such as pitching vibration or rolling vibration of the vehicle body appears as a change in suspension stroke, pitch angle, or roll angle.

A signal indicating the driving force applied to the vehicle 12 by the driving unit 16, and a signal indicating the change in suspension stroke, pitch angle, or roll angle, which occurs in the vehicle body due to the driving force, are input to a notch filter control block (FC) 26. Signals indicating a vehicle speed and an accelerator opening are also input to the notch filter control block 26. The notch filter control block 26 controls a notch frequency of the notch filter 24 to be variable. Specifically, the notch filter control block 26 calculates an amplitude distribution of pitching vibration or rolling vibration of the vehicle body 14 with respect to a frequency of the command driving force based on vibration of the vehicle body 14, in particular, correspondence between the pitching vibration or the rolling vibration and the vehicle body. Then, the notch filter control block 26 controls the notch frequency so as to minimize amplitude of the pitching vibration or the rolling vibration of the vehicle body.

For example, the notch filter control block 26 performs frequency analysis by a Fourier transform method for response motion of the vehicle body to a driving force applied to the vehicle in various driving states of the vehicle. Then, the notch filter control block 26 calculates an amplitude distribution of the pitching vibration or the rolling vibration of the vehicle body with respect to the frequency of the command driving force, and controls the notch frequency so as to minimize the amplitude thereof.

In this case, a signal of the pitching or the rolling of the vehicle body, which is input to the notch filter control block 26, may be subjected to low-pass filter processing by a low-pass filter as indicated by a broken-line block 28 of FIG. 1. Through the low-pass filter processing, vehicle body vibration of a relatively low frequency of about 1 Hz to 2 Hz, which is easily generated by resonance along with a change in steering operation amount such as the accelerator opening degree or the steering angle, is efficiently extracted. As a result, the notch frequency can be more accurately controlled.

The control itself of the notch frequency of the notch filter 24 is not a main subject of the present invention. Accordingly, to effectively reduce the pitching vibration or the rolling vibration of the vehicle body, the notch frequency may be calculated through an arbitrary procedure as long as the notch frequency is calculated to, for example, a value corresponding to a resonance frequency of the vehicle body. For example, as another control procedure, a procedure described in paragraphs [0036] to [0038] of Japanese Patent Application Laid-open No. 2007-237879 filed by the applicant of this application may be used.

The notch filter 24 has its notch frequency controlled by the notch filter control block 26, and a notch degree of the notch filter 24, in other words, an attenuation degree of a component of the notch frequency is controlled depending on increase or decrease of the driver's request driving force, therefore, depending on whether the driver's request is acceleration or deceleration. In this case, as the notch degree increases, the component of the notch frequency is more attenuated and becomes smaller. Notably, the increase or decrease of the driver's request driving force may be determined based on increase or decrease of the accelerator opening.

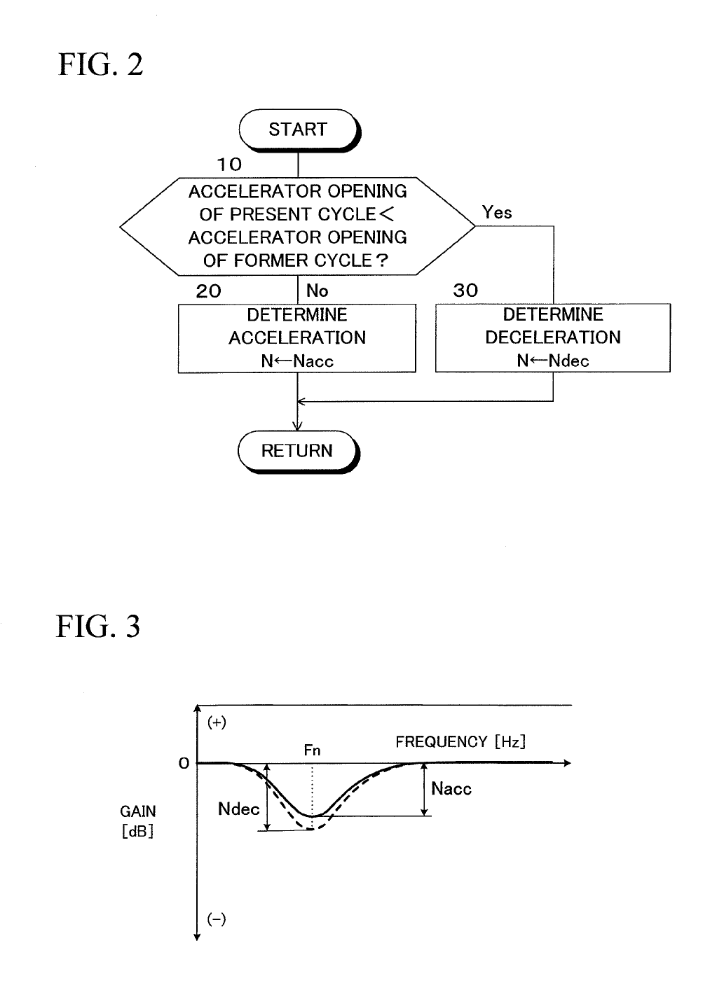

FIG. 2 is a flowchart showing a routine for controlling a notch degree which is achieved by a notch filter control block 26. Control performed in accordance with the flowchart illustrated in FIG. 2 is started by turning ON an ignition switch (not shown), and is repeatedly executed at each predetermined time interval.

First, in Step 10, determination is made as to whether or not the accelerator opening of the present cycle is smaller than that of the former cycle, i.e., whether or not the driver's request driving force decreases. When the determination is positive (YES), the control processing proceeds to Step 30. When the determination is negative (NO), the control processing proceeds to Step 20. It is to be noted that the accelerator opening that is utilized in the determination may be the value which is detected by a device detecting an accelerator opening and is processed by a low-pass filter.

In Step 20, the driver's request is determined to be acceleration (including constant speed) and the notch degree N of the notch filter 24 is set to a notch degree Nacc for acceleration.

In Step 30, the driver's request is determined to be deceleration and the notch degree N of the notch filter 24 is set to a notch degree Ndec for deceleration. While the magnitude relationship between the notch degrees Nacc and Ndec may vary in accordance with specification and running condition of the vehicle, as illustrated in FIG. 3, the notch degree Nacc for acceleration is generally smaller than the notch degree Ndec for deceleration. FIG. 3 shows frequency characteristics of the notch filter 24, in which Fn denotes a notch frequency. As can be understood from FIG. 3, a notch degree N indicates a depth of a V-shaped notch in the frequency characteristics. As the notch degree is higher, an attenuation degree of a driver's request driving force in the notch frequency is higher.

Although the increase in the notch degree accordingly increase the effect to suppress the vibration of the vehicle body, there arises a risk that the driver's request for driving force is not satisfied. However, as the vehicle speed is higher, the engine speed is higher, and the deceleration ratio is higher, the influence is lowered in which the correction of the driving force by the notch filter 24 affords on the variation in driving condition of the vehicle. Accordingly, the notch degree of the notch filter 24 may be controlled in accordance with at least one of the vehicle speed, the engine speed and the deceleration ratio so that the notch degree increases as the vehicle speed, the engine speed and the deceleration increase.

For example, the following table 1 shows the notch degrees in the situation where they are controlled in accordance with the vehicle speed in addition to whether the driver's request is acceleration or deceleration. In the table 1, the values of the notch degree are smaller in acceleration than in deceleration, and increase as the vehicle speed increases. It is to be noted that the ranges shown utilizing “-” in the table 1 include the lower limit values of the ranges.

TABLE 1

| ACCELERATION | | | | | |
|---|---|---|---|---|---|
| OR | VEHICLE SPEED V (km/h) | | | | |
| DECELERATION | 0-40 | 40-60 | 60-120 | 120-180 | 180- |
| ACCELERATION | Nacc1 | Nacc2 | Nacc3 | Nacc4 | Nacc5 |
| DECELERATION | Ndec1 | Ndec2 | Ndec3 | Ndec4 | Ndec5 |

As the accelerator opening is higher, the driver's request driving force may be deemed to be higher. In consequence, the notch degree of the notch filter 24 may be controlled in accordance with the accelerator opening so that as the accelerator opening increases, the notch degree decreases.

For example, the following table 2 shows the notch degrees in the situation where they are controlled in accordance with the vehicle speed and the accelerator opening in addition to whether the driver's request is acceleration or deceleration. In the table 2, the valued of the notch degree are smaller in acceleration than in deceleration, increase as the vehicle speed increases, and decrease as the accelerator opening increases. It is to be noted that the ranges shown utilizing “-” in the table 2 include the lower limit values of the ranges and the unit of the accelerator opening is %.

| ACCELERATOR | ACCELERATION OR | VEHICLE SPEED V (km/h) | | | | |
|---|---|---|---|---|---|---|
| OPENING | DECELERATION | 0-40 | 40-60 | 60-120 | 120-180 | 180- |
| 0-30 | ACCELERATION | Nacc11 | Nacc21 | Nacc31 | Nacc41 | Nacc51 |
| | DECELERATION | Ndec11 | Ndec21 | Ndec31 | Ndec41 | Ndec51 |
| 30-80 | ACCELERATION | Nacc12 | Nacc22 | Nacc32 | Nacc42 | Nacc52 |
| | DECELERATION | Ndec12 | Ndec22 | Ndec32 | Ndec42 | Ndec52 |
| 80- | ACCELERATION | Nacc13 | Nacc23 | Nacc33 | Nacc43 | Nacc53 |
| | DECELERATION | Ndec13 | Ndec23 | Ndec33 | Ndec43 | Ndec53 |

As apparent from the above description, the request driving force calculation block 20, the driving force control block 22, and the notch filter control block 26 respectively function as a request driving force calculation unit, a driving force control unit, and a notch filter control unit of the present invention. The functions of those blocks and the notch filter 24 are achieved under control of the electronic control unit 18. For example, each function is achieved by a calculation control unit such as a microcomputer constructing the electronic control unit 18 in accordance with a control program.

According to the above-described embodiment, determination is made by the notch filter control block 26 as to whether or not the driver's request is deceleration on the basis of the variation in the accelerator opening. When the driver's request is determined to be acceleration (including constant speed), the notch degree N of the notch filter 24 is set to a notch degree Nacc for acceleration. On the other hand, when the driver's request is determined to be deceleration, the notch degree N of the notch filter 24 is set to a notch degree Ndec of deceleration.

As a result, the notch degree of the notch filter can variably be set to an appropriate value in accordance with whether the driver's request driving force increases or decreases. In consequence, in comparison with a conventional vehicle body vibration control device in which the notch degree of the notch filter is constant, in either case where the driver's request is acceleration or deceleration, the signal indicative of the driver's request driving force can more appropriately be processed by the notch filter avoiding excess or deficiency in the notch degree.

In other words, a risk can be reduced that the effect to suppress the vibration of the vehicle body is insufficient due to deficiency in the notch degree, or, conversely, the effect to suppress the vibration of the vehicle body is excessive causing excessive delay of the actual driving force with respect to the request driving force. Accordingly, in either case where the driver's request driving force increases or decreases, the vehicle driving force can be controlled so as to achieve the effect to suppress the vibration of the vehicle body that is as high as possible while satisfying the driver's request for driving force.

In particular, the above-described embodiment is applied to a rear-wheel-drive vehicle. In consequence, nose-lift occurring when the request driving force increases can be reduced as effectively as possible and nose-dive occurring when the request driving force decreases can be reduced as effectively as possible, while satisfying the driver's request for driving force as well as possible.

According to the above-described embodiment, determination is made as to whether or not the driver's request is deceleration, and when the determination is made that the driver's request is not deceleration, the notch degree N of the notch filter 24 is set to a notch degree Nacc for acceleration.

In consequence, as compared to where determination is made as to whether or not the request driving force increases when it is determined that the request driving force does not decrease, and when the request driving force does not increase or decrease, the notch degree is set to a value that is different from the notch degree set when the request driving force increases or decreases, the control of the notch degree can be made simpler.

The specific embodiment of the present invention is described in detail above. However, the present invention is not limited to the above-mentioned embodiment. It is apparent for those skilled in the art that various other embodiments may be employed within the scope of the present invention.

For example, in the above-mentioned embodiment, the notch degree Ndec for deceleration is set to a value larger than the notch degree Nacc for acceleration. However, as the magnitude relationship between the notch degrees Ndec for deceleration and Nacc for acceleration vary in accordance with specification and running condition of a vehicle, the notch degrees Nacc and Ndec may appropriately be set in accordance with specification and running condition of a vehicle to which the vehicle body vibration control device of the present invention is applied.

In the above-mentioned embodiment, in Step 10, determination is made as to whether or not the accelerator opening of this cycle is smaller than that of the former cycle. However, determination may be made as to whether or not the accelerator opening of the former cycle is smaller than that of the present cycle, i.e., whether or not the driver's request driving force increases. In the modification, when the determination is positive, the control processing proceeds to Step 20. When the determination is negative, the control processing proceeds to Step 30.

In the above-mentioned embodiment, when the determination is made that the driver's request driving force does not increase or decrease, the notch degree is set to a notch degree Nacc for acceleration. However, when the determination is made that the driver's request driving force does not increase or decrease, the notch degree may be set to a notch degree Ndec for deceleration.

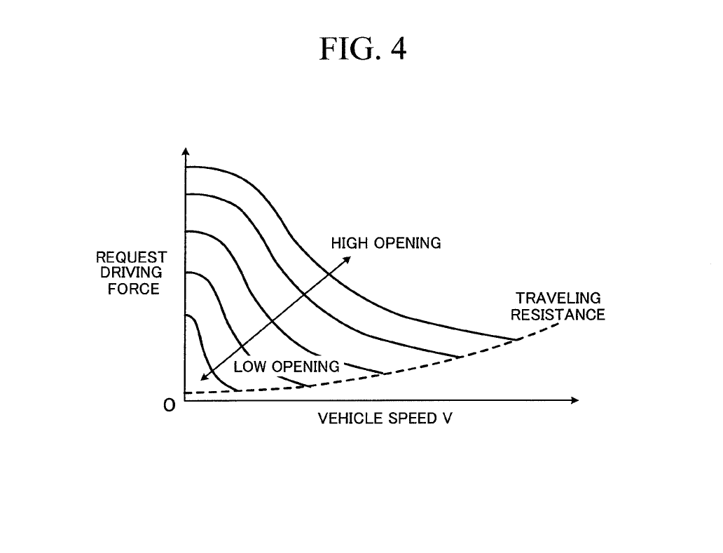

In the above-mentioned embodiment, the driver's request driving force is estimated based on the accelerator opening. However, correction may be performed in such a manner that the driver's request driving force is calculated from a map illustrated in FIG. 4 based on the vehicle speed and the accelerator opening. In FIG. 4, a high opening degree and a low opening respectively mean a large accelerator opening and a small accelerator opening.

In the above-mentioned embodiment, the driving unit 16 includes the engine and the transmission in combination, and signals indicating a target throttle opening and a target deceleration ratio calculated based on the command driving force or the like are output to the driving unit 16. However, when the vehicle body vibration control device of the present invention is applied to a vehicle having a hybrid system mounted thereon, outputs of an engine and an electric motor may be controlled based on the command driving force or the like. When the vehicle body vibration control device of the present invention is applied to an electric vehicle, an output of an electric motor may be controlled based on the command driving force or the like.

In particular, when the vehicle body vibration control device of the present invention is applied to the vehicle having a hybrid system mounted thereon or to the electric vehicle, torque of the electric motor is lowered along with increase of the revolution speed thereof, and thus the notch degrees shown in the above tables 1 and 2 may be set lower as the vehicle speed is higher.

In the above-mentioned embodiment, the vehicle is the rear-wheel-drive vehicle. However, the vehicle body vibration control device of the present invention may be applied to a front-wheel-drive vehicle and a four-wheel-drive vehicle.

1. A vehicle body vibration control device for a vehicle, comprising:
a request driving force calculation unit configured to calculate a request driving force of by a driver;
a driving unit configured to apply a driving force to the vehicle;
a driving force control unit configured to control the driving unit based on a command driving force; and
a notch filter configured to receive a signal indicating the request driving force from said request driving force calculation unit, subject the signal to filter processing, and output the signal subjected to the filter processing to said driving force control unit as a signal indicating the command driving force, said notch filter having a notch frequency set to a value for reducing a frequency component of vibration of a vehicle body;
wherein said vehicle body vibration control device comprises a notch filter control unit configured to determine as to whether or not the driver's request driving force increases and variably set the notch degree of said notch filter on the basis of the result of said determination.

2. A vehicle body vibration control device for a vehicle according to claim 1, wherein said notch filter control unit, when it determined that the request driving force does not increase or decrease, sets the notch degree of said notch filter to a value that is equal to one of the notch degree set when it is determined that the request driving force increases or the notch degree set when it is determined that the request driving force decreases.
